(19) United States
(12) Patent Application Publication
(10) Pub. No.: US 2002/0196708 A1
(43) Pub. Date: Dec. 26, 2002

(54) Method for preventing collisions between whales and boats

(76) Inventor: Jack V. Smith, Arden, NC (US)

Correspondence Address: Jack V. Smith, P.O. Box 156, Arden, NC, 28704, US

(21) Appl. No.: 10/227,819

(22) Filed: Aug. 27, 2002

Related U.S. Application Data
(63) Continuation-in-part of application No. 08/917,174, filed on Aug. 25, 1997.

(51) Int. Cl. H04B 1/02

(52) U.S. Cl. 367/139; 340/573.2

(57) ABSTRACT

A whale and/or manatee device designed to be installed on boats externally or internally or be hand held which will emit an continuous signal (continuous sounds in the form of manatee or whale signals replicated or copied from actual manatees or whales sounds) that is noticeable by whales and/or manatees so that the whales and/or manatees can move out of the way of impending danger of collision with a boat.

### PRIOR APPLICATIONS

This application if a continuation-in-part of application Ser. No. 08/917,174, filed Aug. 25, 1997, which is on appeal.

### BACKGROUND OF INVENTION

1. Field of the Invention

This invention relates to a device designed to be installed on boats externally or internally or be hand held which will emit an alarm signal (continuous sounds in the form of manatee or whale signals replicated or copied from actual manatees or whales) that is noticeable by whales and/or manatees so that the whales and/or manatees can move out of the way of impending danger of collision with a boat.

2. Description of the Related Art

It is common knowledge in the art that whales and manatees are mammals and breath air. When these mammals sleep or rest it is often near or on the surface of water. Virtually all species of whales (cetaceans) are known to produce sounds, and these sounds may serve as an important means of interaction and communication. All odontocetes (whales) thus far investigated produce short, pulse-type sounds that function in echolocation. In addition, most species are also known to emit high-pitched squeals and whistles (long continuous sounds) that appear to be used as part of social behavior. The present art distinguishes between the pulsed sounds used for long distance communications and continuous sounds or whistles that are used as part of social interaction between the marine animals. Although there is no evidence that these sounds represent anything comparable to a true language, there is little doubt that they are used to denote specific emotional states, for example, fright, hunger, or sexual readiness.¹ In addition manatees are known to produce underwater sounds that apparently function to signal alarm, maintain contact and possibly denote emotive state.^{2,3} It is also known within the art that manatees cannot hear certain sounds that are produced by motors and propellers, thus making manatees very susceptible to injury and or death by collision with a boat, motor, and/or propeller. And in fact it has been shown that the use of a continuous signal (which can include a whistle), which is know in the art4, is “mostly associated with close-range interactions”. In addition, it is know in the art that the pulsed calls are related to long distance calls “between pod members when foraging or traveling”⁴ this is obviously the opposite type of call or response that is the present art desires to use when the purpose of the present art is to prevent close or direct impact collisions between boats and marine animals.

Whales and manatees are an endangered species and on the protected species list and seem to produce no harm to the environment they swim in and thus are peaceful inhabitants of planet earth. And, any steps that can be taken to protect them and other endangered species should be taken. Man (a mammal) on the other hand is well known for its callous treatment to its environment whether it is on land or water. One of the great hobbies of man is boating. And over the recent years there have been numerous cases of large sailboats and other vessels that have gone down (sunk) because of collisions with whales. When a sailboat weighing many tons collides with a creature or creatures that weigh many tons loss of life is bound to happen. Not only to the humans manning the boat but also to the whales themselves. Sailboats and other silent powered vessels produce relatively no sound when under way that would not be disguised by the normal wave action of the ocean. Thus, a whale sleeping would not hear the vessel coming towards it and would not be capable of moving out of the way of the impending collision. The human driving the vessel for example, would not be able to easily see the whale if it were dark or if the whale was just under the surface. And for the shipmates it would be very frightening to wake up in your bunk on a sailboat to find yourself submerged under a boat that had just collided in the dark of night with a whale. The present device can prevent this catastrophe. The device can be mounted externally or internally on the boat or be hand held and constantly emitting an alarm signal (continuous sounds in the form of manatee or whale signals replicated or copied from actual manatees or whales) that is noticeable by whales so that the whales can move out of the way of impending danger of collision with a boat.

As mentioned manatees are on the endangered list and the protected species list and like the whale seem to cause little or no harm to the environment that it lives in. Every year however, manatees are killed and injured by boats and boat propellers. The present device can prevent this catastrophe. The device can be mounted externally or internally on the boat and while constantly emitting an alarm signal (continuous sounds in the form of manatee or whale signals replicated or copied from actual manatees or whales) that is noticeable by manatees so that the manatees can move out of the way of impending danger of collision with a boat.

There are of course general-purpose audio devices designed for signaling that will not work in an aqueous (water) environment, such as in U.S. Pat. No. 3,785,335, which discloses a conventional air horn operated by gas. This device cannot work under water and is not capable of sending a signal that could be discernible by whales or manatees as an alert that would signal whales or manatees of impending danger, thus this device has no relative bearing on the present device but was designed for use on boats and can also be blown into for activation. Another device, U.S. Pat. No. 4,950,107, which discloses a signaling device for scuba divers and more specifically concerns an audible alarm only detectable above water when the scuba diver is on the surface of said water. This device can go under water, but again does not work in an aqueous environment (water). An even more remotely related patent is U.S. Pat. No. 5,559,759 by Gerstein, this patent discloses a method for alerting Manatees but requires the use of pulsed sounds, variable gain preamp, sonar projector, waveform generator, and boat speed indicator which are not requirements of the present art and is in fact is why the present art is novel over the prior art for its actual functionality. In fact the present art uses a continuous signal which as know in the art⁴ is “mostly associated with close-range interactions”. Therefore the prior art of Gerstein does the opposite of the intent of the present art and has no relative bearing on the present art. In addition, it is know in the art that the pulsed calls which are related to long distance calls “between pod members when foraging or traveling”.⁴ With this said and known in the art, the use of Gerstein in close proximity of manatees or whales is the opposite of what is actually needed in the present art which is the prevention of collisions which occur from close to zero distances. The use of a continuous signal is needed for response to close interaction such as a collision. This would not be the result of the pulsed signal as required by Gerstein. Also note, Gerstein taught none of the present art nor mentioned the use of continuous signals (e.g. continuous sounds in the form of manatee or whale signals replicated or copied from actual manatees or whales) for the prevention of collision. In addition, the Gerstein device has no way to enable it for use, assumptions can be made that the device is designed to be placed in water, possibly on channel markers, or robotic boats with the ability to know the direction of oncoming vessels relative to manatees. The actual use of the device can only be imagined. This technology of course is not disclosed possibly because it is not currently available short of star wars technology. Another device disclosed by Menezes U.S. Pat. No. 4,922,468, which is a device designed to gather up marine animals and kill them, Quite the opposite affect of the present device. The Menezes device requires the use of varying stimuli until a desired response if obtained. This sounds like an easy to use device that will work for killing animals but the utility for the use as described by the present art has no relative bearing.

In addition, the Gerstein and Menezes devices do not mention or teach the use of Manatee or Whale sounds the present art of Smith does, Gerstein and Menezes devices do not mention or teach the use of or installment of a device into or onto a vessel as described in detail in the present art, Gerstein and Menezes devices do not mention or teach the use of a computer or control device the Smith device does, Gerstein and Menezes devices do not mention or teach the use of auditory storage/playback devices the Smith device does, Gerstein and Menezes devices do not mention or teach the use of programmer the Smith device does, Gerstein and Menezes devices do not mention or teach the use of hand held device the Smith device does, Gerstein and Menezes devices do not mention or teach the use of continuous manatee or whale sounds at 3 to 26 kHz and the Smith device does, Gerstein and Menezes devices do not mention or teach the use of continuous signal (continuous sounds in the form of manatee or whale signals replicated or copied from actual manatees or whales) the Smith device does, in fact the Gerstein and Menezes devices require the use of a pulsed signal which is not required not nor wanted for use by the Smith device because of the unfavorable effect that a pulse signal represents. These and many other reasons are why the Gerstein and Menezes prior art are antiquated, non-functional and not relative to the new and improved art of Smith.

Outside of the mentioned devices, there is nothing even is closely related to the uniquely invented properties of the present device. There are other devices in the art that are used to warn away animals and pests using sound, but none of these devices uses a signal that is detectable by its own species as an alert or fright signal that could be interpreted as inter species communications, in fact, none of these sounds produced to get rid of animals and pests could be reproduced by the same. These warning devices also in many cases harm the animals and pests by using harmful sounds that are painful to the animals and pest and sometimes cause death (in the case of an ultrasonic flea collar). Not only do these devices not have any relative bearing on the novelty of the present device but also, of course these devices would not work in an aqueous environment. The prior art mentioned when combined as a whole does not constitute the present device or resemble it in any manner. One of the most unique inventive processes of the present device is that all prior alarms mentioned were designed to warn or alert scuba divers or other humans. Now it is known in the art that humans are considered sentient and thus self-preservation is a primary driving force for survival of the species, and it is common to find safety systems for aiding in self-preservation. But, now this present device is for the safety of a species that has shown the ability to respond to certain stimuli and who's to say what their level of sentience is. To say the least if whales and/or manatees could produce a system to alert fellow species members of danger they would do so.

### SUMMARY OF THE INVENTION

Accordingly, the invention includes a means for enabling a device that is present on a vessel in water that can produce continuous sound in the form of manatee or whale signals replicated or copied from actual manatees or whales, means for the activated device to be interfaced with the surface of the water, submerged, interfaced with the inside hull of the vessel, externally mounted on a portion of the vessel that is above water, or portable, means for the sound produced to be transmitted through an aqueous medium for a considerable distance, means for producing a sound or sound vibrations that can be detected by whales and/or manatees.

This invention provides an efficient and effective means for signaling (alerting) whales or manatees of a vessel in the immediate vicinity. Of particular interest is the ability of the present device to function while being interfaced with the inside of a vessel so that the audible sound produced for detection by whales or manatees can be transmitted through the hull of the vessel or the ability of the present device to be in fluid connection with the water that the vessel is floating on with the means to produce an audible sound detectable by whales or manatees.

The device of this invention provides a flexible system for alerting whales or manatees to the presence of vessels by allowing the activation means of the present device to have many modes such as controller that activates the device by remote control, switch, timer, depth gauge, or other means. In addition, the present device can be powered electrically or mechanically by batteries, solar power, engine alternator, shore power, or other means. The present device can be activated to emit continuous sound constantly, separately (the device can emit 2 or more different sounds that can be noticed by whales and/or manatees simultaneously), activated for short periods of time, or be activated by a separate device such as radar or sonar, or by some other means.

The device of this invention is particularly useful for alerting (signaling) whales or manatees of the danger of being hit by an incoming vessel. This device provides a single cohesive system that is designed to work with the minimum of effort by the boater to perform a complex operation that can have the favorable outcome of saving whales and manatees and preventing loss of life.

### A BRIEF DESCRIPTIONS OF THE DRAWING

FIG. 1 Shows a flowchart of the method for activation of the alarm device.

FIG. 2 Shows one possible configuration of the components of the alarm device

FIG. 2b Shows the alarm device being held by boat's crew.

FIG. 2c Is a perspective view of the alarm device mounted onto the inside of the boat's hull.

FIG. 2d Is a perspective view of the alarm device mounted onto the outside surface of the boat's hull.

FIG. 3 Shows a flow chart of the input instruments as they are incorporated into the alarm.

FIG. 4 Illustration of portable alarm device in contact with the surface of the water.

### DETAILED DESCRIPTION OF THE INVENTION

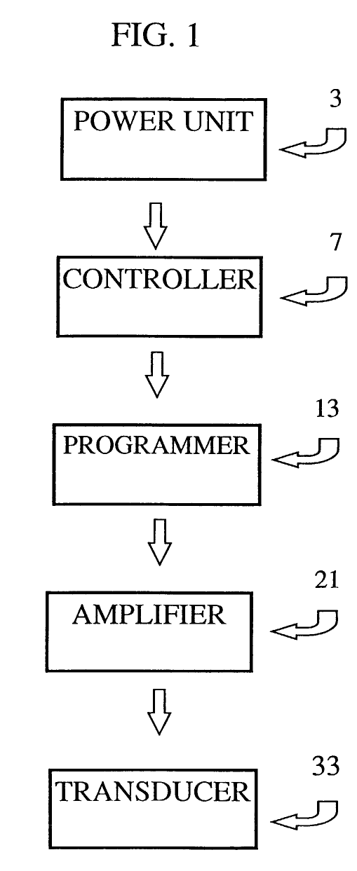

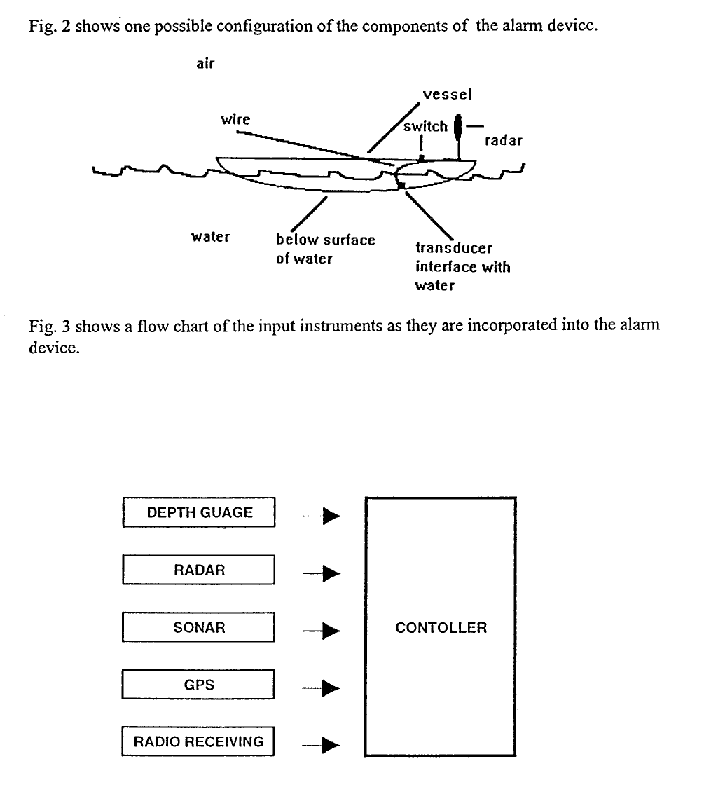

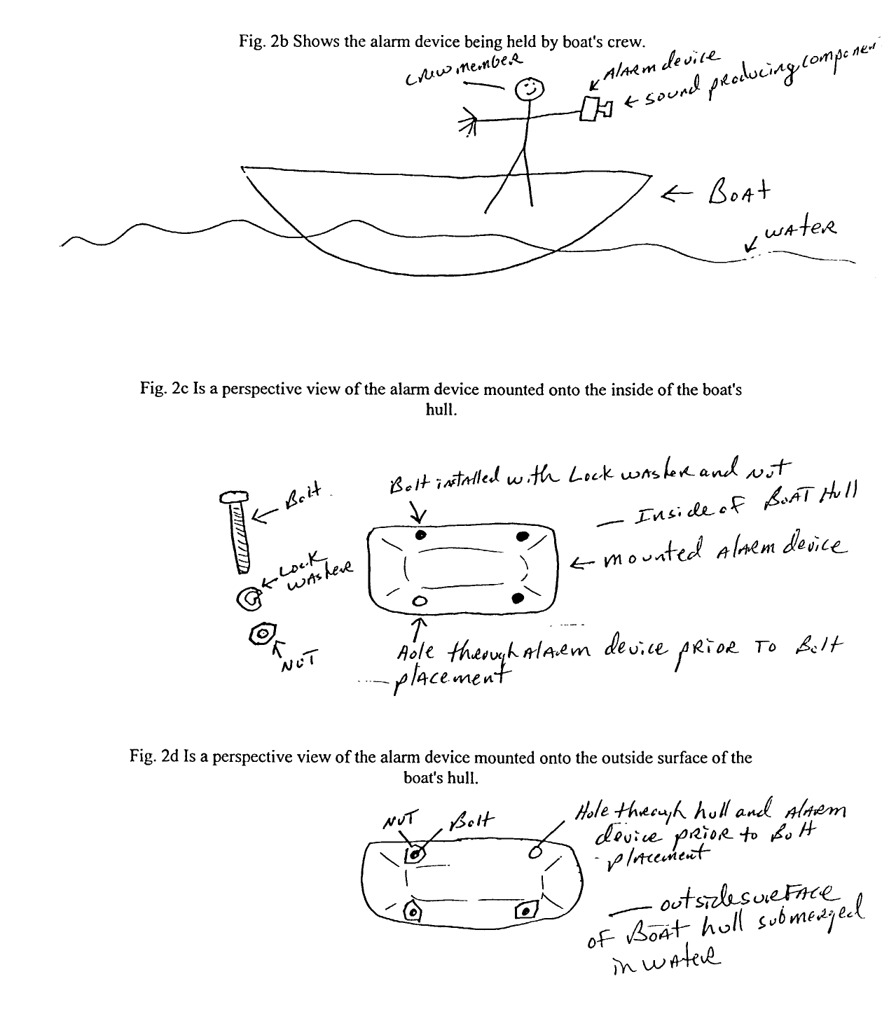

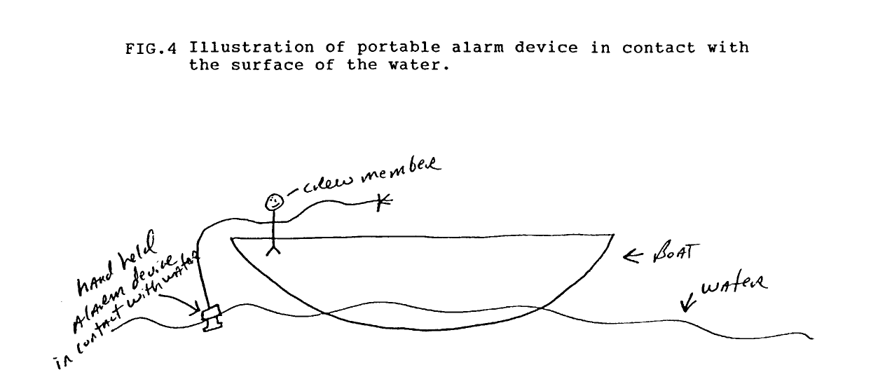

The present invention is an alarm (that produces a continuous sound that is detectable by whales and/or manatees in the form of manatee or whale signals replicated or copied from actual manatees or whales) device, which is specifically designed and arranged to be used as an single cohesive system when installed on boats that are in water or other floating vessels or it can be hand held. Referring now to the flow diagram of FIG. 1, certain elements of the alarm system are shown to illustrate the method for activation of the whale and/or manatee alarm. In particular, the controller 7 (which controls the alarm by using an on/off switch or similar device, in that when then switch is on, the controller allows power in the form of electricity, magnetic, electrostatic, or other means to be transferred from the power unit 3 to the programmer 13, the amplifier 21 and/or the transducer 33) is activated by a switch, button, remote or other input means that when activated allows the power supplied (battery, AC (alternating current) and or DC (direct current), solar, wind or by some other means) by the power unit 3 to be able to be transferred to the programmer 13 which controls the particular continuous sound desired depending on whether the whales and/or manatees are the target of the activated alarm. The programmer 13 is a frequency controller that is programmable from a keyboard, a switch, or computer. Once the frequency is determined by the programmer 13 the data (signal) is then transferred to the amplifier 21, which was also empowered by the controller 7 during controller 7 activation, the amplifier that amplifies the signal to the desired intensity predetermined by the programmer 13. The amplifier then sends the signal to the transducer 33 (electromechanical), which converts the signal from electrical energy to continuous sound energy (continuous sounds in the form or manatee or whale signals replicated or copied from actual manatees or whales) that is transmitted through water, which is detectable, by whales and/or manatees. The transducer can be a speaker, a sound channeling device, ultrasonic transducer pair (receiver and transmitter), or similar device. This method which is illustrated specifically by FIG. 1, can be installed on a vessel or boat in the form of a device that can be placed on the outer hull of the vessel or boat, or interfaced with the outer surfaced of the vessel or boat, or the device can be placed on the inner hull of the boat, or be hand held or installed by some other means. The installation as illustrated in exacting detail leaving no doubt as to the installation is shown in FIG. 2c. In fact as illustrated in the previous figure mentioned bolts, lock washers, nuts as well as a template for the installation are shown. Prior to the installation of the device into the hull of the boat a hole will need to be cut into the hull to allow the installation as illustrated in FIG. 2c. A screwdriver, players and other tools may need to be used during the installation, in fact the use of marine caulk around the hold during installation will prevent any leakage after installation. Hence, the present invention is a alarm device that will alert whales and/or manatees to danger and can be adapted readily and integrated with conventional boating equipment, without any modification to the boating equipment and without in any way interfering with its normal operation.

This device can be described by several best modes in detail for example, if the device were to be mounted on the inside bottom hull of the boat, outer hull of the boat, or be hand held, the device as described in FIG. 1, it can be constructed and used as follows: the controller 7 in this example is an on off toggle switch (which is a full sized toggle switch with wire leads, the contacts can be rated at 6 amp@125 VAC; (volts alternating current) 32 amp@250 VAC, that has the leads connected by wire (rated at 12 gauge wire with maximum 15 amps@120 V (volts)) to the power unit 3 which in this example is a 12 VDC (volts direct current) marine battery, controller and amplifier. Thus, when the switch is turned on the electrical energy is sent from the battery to the controller 7 and amplifier 21. The controller 7 is this example is a 3-button keypad with a preprogrammed microprocessor to allow 3 separate functions. First button when depressed (the other two buttons the second and third ones would be in the “up” position) will allow a signal(s) to be sent from the transducer 33 through the water that would only alert whales by the use of continuous sounds in the form of whale signals replicated or copied from actual whales, the second button when depressed (the other two buttons the first and third ones would be in the “up” position) would allow a signal(s) (continuous sounds in the form of manatee or whale signals replicated or copied from actual manatees or whales) to be sent from the transducer 33 through the water that would alert both whales and/or manatees, and the third button when depressed (the other two buttons the first and second ones would be in the “up” position) would allow a signal (continuous sounds in the form of manatee signals replicated or copied from actual manatees) to be sent that would only alert manatees. Now, once one of the three buttons on the controller 7 is depressed the preprogrammed signal is then sent to the amplifier 21 (8 watt amplifier with a driver (that can deliver a load as low as 1.6 ohms; 11W (watts)@16 V supply) that amplifies the signal (continuous sounds in the form or manatee of whale signals replicated or copied from actual manatees or whales) to the preprogrammed specification and forwards the signal to the electromechanical transducer 33 (in this example is a 4 inch speaker (frequency range of 400 to 13,000 hertz, 40 watt peak power)), that in turn sends a signal (a vibration pattern or sound) towards the inside bottom hull of the boat, outer hull of the boat, or in the case of a hand held the device is interfaced with the water. This sound, which is then transferred from the device to the water medium, that allows the alerting of whales and/or manatees. This method which is illustrated specifically by FIG. 1, can be installed on a vessel or boat in the form of a device that can be placed on the outer hull of the vessel or boat, or interfaced with the outer surfaced of the vessel or boat, or the device can be placed on the inner hull of the boat, or be hand held or installed by some other means. Hence, the present invention is a alarm device that will alert whales and/or manatees to danger and can be adapted readily and integrated with conventional boating equipment, without any modification to the boating equipment and without in any way interfering with its normal operation.

Without further analysis, the foregoing will so fully reveal the gist of the present invention that others can, by applying current knowledge, readily adapt it for various applications without omitting features that from the standpoint of prior art, fairly constitute essential characteristics of the generic to the art and, therefore, such adaptations should and are intended to be comprehended within the meaning and range of equivalence of the appended claims.

Accordingly, an invention has been described which is capable of producing a continuous signal in the form of manatee or whale signals replicated or copied from actual manatees or whales intended for whales and/or manatees, but which is adapted for integration into conventional boating equipment. The resulting combination is practical and easy to use, and does not otherwise interfere with the safe operation of boating equipment or the actions of boaters.

Although a preferred embodiment of the invention has been disclosed herein for illustration, it should be understood that various changes, modifications and substitutions may be incorporated in such embodiment without departing from the spirit of the invention as defined by the claims, which follow.

What is claimed is:

1. A method of producing an continuous sound in the form of manatee or whale signals replicated or copied from actual manatees or whales that are detectable by whales and/or manatees wherein the device can be installed on boats externally, internally, or be hand held comprised of:
a) power unit; and
b) controller; and
c) programmer; and
d) amplifier, and
e) transducer.

2. An apparatus for use with boating equipment that is in water to produce an continuous audible sound that is detectable by whales and/or manatee in the form of manatee or whale signals replicated or copied from actual manatees or whales comprising:
means, including an continuous audible sound in the form of manatee or whale signals replicated or copied from actual manatees or whales means being adapted to boats externally, internally, or be hand held without interfering with boating;
means, for said alarm means to be activated by a controller, wherein said controller means is empowered by a power unit, wherein said power unit provides a means for supplying electrical, magnetic, or electrostatic to said controller means and to a programmer, wherein said programmer provides a means that sends a specific programmed signal to the amplifier, wherein said amplifier provides a means that sends a signal to the transducer, wherein the transducer produces a means that sends an continuous audible sound that is transmitted through said water that is detectable by whales and/or manatees.

3. An apparatus of claim 2, wherein said continuous audible sound means can be interfaced with the surface of the water, submerged, interfaced with the inside hull of the vessel, externally mounted on a portion of the vessel that is above water, or portable means.
